(19) United States
(12) Patent Application Publication
(10) Pub. No.: US 2014/0288859 A1
(43) Pub. Date: Sep. 25, 2014

(54) SYSTEM AND METHOD FOR ESTIMATING PNEUMATIC PRESSURE STATE OF VEHICLE TIRES

(71) Applicant: NEOMATIX LTD., Tel Aviv (IL)

(72) Inventor: Kfir Wittmann, Tel Aviv (IL)

(73) Assignee: NEOMATIX Ltd., Tel Aviv (IL)

(21) Appl. No.: 14/356,217

(22) PCT Filed: Nov. 1, 2012
(86) PCT No.: PCT/IL2012/050434

§ 371 Date: May 5, 2014

Related U.S. Application Data
(60) Provisional application No. 61/555,048, filed on Nov. 3, 2011.

(51) Int. Cl. G06K 9/62; G01M 11/08; G01M 17/02; G06T 7/60

(52) U.S. Cl. CPC G06K 9/6202; G06T 7/60; G06T 7/602; G01M 11/081; G01M 17/027; G06T 2207/30252
USPC 702/55

(57) ABSTRACT

A system and a method for estimating pneumatic pressure state of vehicle's tires where the system includes one or more sensor units, each including an optical sensor such as camera for acquiring at least one image of at least one wheel of the respective vehicle and a controller including a processor for receiving image data of a respective wheel of the vehicle from the sensor units and analyzing thereof for estimating a pneumatic pressure state of one or more of the vehicle's tires using special image analysis processes. The processor is also configured to allow presenting the estimated pneumatic pressure state of each respective tire.

### CROSS-REFERENCE TO RELATED PATENT APPLICATIONS

This application claims the benefit of Provisional patent application No. 61/555,048 filed Nov. 3, 2011, which is incorporated herein by reference in its entirety.

### FIELD OF THE INVENTION

The present invention generally relates to systems and methods for monitoring pneumatic pressure and more particularly to systems and methods for estimating pneumatic pressure in vehicles' tires.

### BACKGROUND OF THE INVENTION

The pneumatic pressure (inflation state) of a vehicle's tires dramatically influences various aspects such as, inter alia, driving safety, fuel consumption and life expectancy of the tires. An underinflated or overinflated tire will wear off much quicker than a tire that is kept inflated at the manufacturer recommended pneumatic pressure. Another aspect influenced by the inflation state of the vehicle's tires is the driving experience. Properly inflated tires insure a much more accurate steering, shorter acceleration periods and improved vehicle stability.

Public awareness has greatly increased, and in the United States, legislation such as the TREAD Act, requires passenger cars to be equipped with Tire Pressure Monitoring Systems (TPMS). Similar legislation gradually entered the European Union starting in the year 2012, and many manufacturers of cars, tires and vehicle accessories and safety equipment are rising to the challenge.

### SUMMARY OF THE INVENTION

According to some embodiments of the invention, there is provided a system for estimating pneumatic pressure state of vehicle tires that includes: (a) at least one sensor unit, each including at least one optical sensor for acquiring at least one image of at least one wheel of the respective vehicle; and (b) at least one controller including at least one processor for receiving image data of a respective wheel of the vehicle from the sensor unit and analyzing thereof for estimating a pneumatic pressure state of a tire of the wheel, where the processor is configured to allow presenting the estimated pneumatic pressure state of each respective tire.

Optionally, the image analysis includes estimating value of at least one predefined parameter of the respective tire in the image and comparing the estimated parameter with a known value of a corresponding reference parameter of a properly inflated tire by using at least one database for retrieving known parameter values.

Optionally, the system further includes one or more input devices such as touch screen, keypad and the like for allowing a user to input data therethrough, where the input data comprises at least the type of the respective vehicle, wherein the processor uses this input data for estimating the pneumatic pressure state of each tire of the respective vehicle.

The sensor unit may include a plurality of sensor units located such as to allow a vehicle to pass there-between for acquiring images of all the wheels of the respective passing vehicle when passing through the sensor units, wherein upon passage the sensor units enable identifying and indicating the respective left/right and rear-front location of each tire in each image. The database may be configured such that each known parameter value is associated with a specific vehicle type and with a tire side indication indicative of the front/rear side of the respective tire in the image for allowing the processor to compare the estimated value of the parameter with a corresponding parameter value of a properly inflated tire that is of the same vehicle type and tire side.

Additionally or alternatively, the parameter includes at least one of: footprint length; footprint angle; sidewall height.

The system optionally further includes at least one temperature measuring device such as an infrared (IR), sensor for measuring the temperature of the respective tire, where the processor, which is configured to communicate with the temperature measuring device, enables using the temperature of the respective tire for estimating its pneumatic pressure state in respect to known values of properly inflated tires within the respective temperature range.

According to some embodiments, the system is located at a designated passageway for allowing vehicles to have their tires' pneumatic pressure state estimated while passing through this designated passageway, wherein the at least one sensor unit includes a plurality of sensor units configured for producing two-dimensional (2D) images of each pair of tires of the vehicle substantially simultaneously by being installed at opposite sides of said passageway,

The system optionally also includes an output device such as a screen, a speaker and/or a printing device for presenting the outputted estimated pneumatic pressure state.

Optionally, the system further includes a plurality of pressure detectors each located over the passageway such that the tires of the passing vehicles are forced to role thereover when passing therethrough, wherein the pressure detectors are configured for estimating pressure applied by each tire, wherein detection of each applied pressure of each of a respective vehicle's tires is received by the processor and used thereby in estimating tires' pneumatic pressure.

The system may also include an automatic vehicle type identification mechanism for automatically identifying the type of the respective vehicle, wherein the estimation of the pneumatic pressure of each tire of the respective vehicle is carried out according to the type of the respective vehicle. For example, the vehicle identification mechanism is configured for one of: identifying the license number of the vehicle via LPR; RFID identification of the vehicle, wherein the processor enables accessing at least one database for associating the identified license number or RFID code with a type of the respective vehicle.

The system optionally also includes a mechanical positioning mechanism to allow adjusting the location of each optical sensor over at least one axis, wherein the mechanical positioning mechanism is electrically controlled by the controller.

According to other embodiments of the invention, there is provided a method of estimating pneumatic pressure in tires of vehicles that includes: (a) acquiring at least one image of at least one of wheel of a vehicle, using at least one sensor unit comprising an optical sensor; (b) analyzing each respective image of each tire of the respective wheel for estimating value of at least one parameter of this tire related to pneumatic pressure thereof; (c) estimating pneumatic pressure state of the respective tire by comparing the estimated value of the parameter with a known parameter value of a properly inflated corresponding tire; and (d) presenting an indication of the estimated pneumatic pressure state.

Optionally, the at least one parameter includes at least one of: footprint length; footprint angle; sidewall height.

The method optionally additionally includes identifying type of the respective vehicle and identifying the rear/front side of each wheel in each image, wherein the estimated parameter is compared to a corresponding known parameter associated with the same vehicle type and tire side.

The method may further include receiving input data indicative of the type of the respective vehicle. The type of the vehicle may be rather automatically identified by using at least one sensor for sensing at least one parameter associated with the type of the respective vehicle or identified by receiving user's input indicative of the vehicle's type.

The method additionally or alternatively further includes adjusting the positioning of each optical sensor according to the identified vehicle type before acquiring image of its wheels.

Optionally the method also includes executing a preliminary testing process in which each acquired image is tested to check for defects thereof and verify that it passes at least one predefined quality criteria, wherein upon failure of an image to pass at least one of the tested criteria, the sensor is adjusted according to the detected defects for acquiring a new image of the respective wheel. The adjustment may include, for example adjusting zoom and/or dynamic range of the sensor, wherein the sensor includes at least one camera with adjustable zoom and dynamic range.

### BRIEF DESCRIPTION OF THE DRAWINGS

FIG. 1A is a schematic illustration of a system for estimating and presenting pneumatic pressure in vehicles' tires, according to some embodiments of the present invention.

FIG. 1B is a block diagram of a system for estimating and presenting pneumatic pressure of vehicles' tires, according to some embodiments of the present invention.

FIG. 2 is a flowchart, schematically illustrating a method for estimating and presenting pneumatic pressure in vehicles' tires, according to some embodiments of the present invention.

FIGS. 3A-3C include documented pictures showing how the pneumatic pressure level of a tire influences the footprint of the tire: FIG. 3A shows a photograph of a vehicle's tire inflated to 34 PSI (pounds per square inch); FIG. 3B shows a photograph of a vehicle's tire inflated to 24 PSI; and FIG. 3C shows a photograph of a vehicle's tire inflated to 15 PSI.

FIGS. 4A-4C include documented pictures showing how the pneumatic pressure level of a tire influences the footprint angle of the tire: FIG. 4A shows a photograph of a vehicle's tire inflated to 28 PSI (pounds per square inch); FIG. 4B shows a photograph of a vehicle's tire inflated to 22 PSI; and FIG. 4C shows a photograph of a vehicle's tire inflated to 15 PSI.

FIGS. 5A-5C include documented pictures showing how the pneumatic pressure level of a tire influences the sidewall height measured between the touch point between the tire and road/ground and the tire's inner border with the rim: FIG. 5A shows a photograph of a vehicle's tire inflated to 36 PSI (pounds per square inch); FIG. 5B shows a photograph of a vehicle's tire inflated to 27 PSI; and FIG. 5C shows a photograph of a vehicle's tire inflated to 10 PSI.

FIG. 6 shows experimental results of the relation between the footprint length of the four tires of a vehicle, following the deflation of the front left tire.

FIG. 7 shows experimental results of the relation between the footprint angle and the tire pneumatic pressure level.

FIG. 8 shows experimental results of the relation between the sidewall height and the pneumatic pressure level.

FIG. 9 is a flowchart, schematically illustrating a preliminary testing process for pre-checking quality related characteristics of the respective image before estimating the pneumatic pressure state of the tire, according to some embodiments of the present invention.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention, in some embodiments thereof, provides methods and systems for estimating pneumatic pressure state (inflation rate) in tires of vehicles and presenting, logging and transmitting an indication of the estimated pneumatic pressure state by external inspection and without driver involvement.

The term “pneumatic pressure state” of a tire refers to any indication of the inflation state of the tire such as for example the actual value of the pneumatic pressure of the tire (e.g. in PSI), a parameter that is influenced by the inflation rate of the tire such as the portion of the tire's external periphery that is in contact with the ground (footprint) and the like.

According to some embodiments of the invention, the system includes one or more sensor units, each sensor unit includes one or more optical sensors such as cameras for acquiring at least one image of each tire of the respective vehicle and for outputting image data of each such acquired image; and a controller including a processor for receiving image data from the sensor units and analyzing thereof for estimating a pneumatic pressure state of each tire of each respective image. The processor is configured to allow outputting the estimated pneumatic pressure state of each respective tire via one or more presentation means and methods such as by presenting the value (in [PSI]) of the pressure of each tire of the vehicle and indicating the tire's location (rear left/right or front left/right). In this way the driver or any other person is immediately acknowledged of his/her tires' inflation state and therefore is able to handle under or over inflated tires of his/her vehicle as quickly as possible.

According to some embodiments of the invention, the processor estimates pneumatic pressure state of each respective tire by estimating value of one or more parameters calculated by using image analysis of the tires' images outputted by the optical sensors (e.g. cameras) and comparing each of these parameter values with an equivalent known value of the respective parameter, by accessing at least one database comprising relevant known parameters values. The image analysis of each respective tire-image includes measuring one or more measures such as the footprint of the tire (the length of the tire part contacting the road/ground) and/or other measures such as the sidewall height of the tire between the outer and inner surface-sides of the tire measured along an axis the passes through an assessed middle touch point between the tire and ground. This measure or parameter value is then compared to known values of an equivalent “properly inflated tire”, which relates to the same parameter (footprint or sidewall height for instance) of a tire that is inflated to the standard manufacturer's recommended inflation pressure rate. This is in relation to a known reference vehicle-loading configuration, meaning that exceeding the respective known reference shows under-inflation of tires, over-loading of the vehicle or a combination of both. These are conditions that endanger the driver, passengers and cargo, as well as increase fuel consumption and tire wear-and-tear.

Since, tire recommended pneumatic pressure is associated both with the vehicle's type (exact car type) and the location of the tire (rear or front) these “tire-related characteristics” should be known before estimation begins. These characteristics, and optionally other characteristics, may be inputted by the user via a designated input device of the system or automatically identified by the system. For example, to automatically identify the vehicle type, one of the cameras may be able to acquire image of the vehicle's license number, while the processor is configured and designed to allow identifying the number from the acquired image through image analysis and search through a database including vehicles characteristics such as type, year of manufacturing and the like associated with the vehicles' particular license number. Alternatively, the vehicles may include a radio frequency based ID (RFID) tag or any other identifiable tag or device that allows a designated sensor of the system to read a code from the respective tag for identifying the vehicle's characteristics including the vehicle type.

According to some embodiments of the invention, the system is located at a predefined passageway, defining an area in which the vehicle is directed to pass, where a plurality of stationary cameras, located at different sides of the passageway, photograph images of the rear and front tires of the vehicle substantially simultaneously. All the cameras may be configured to communicate with a nearby and/or a remote controller, which includes a processor for carrying out image analysis of the images of the vehicle's tires to determine for each one if it is properly/under/over inflated.

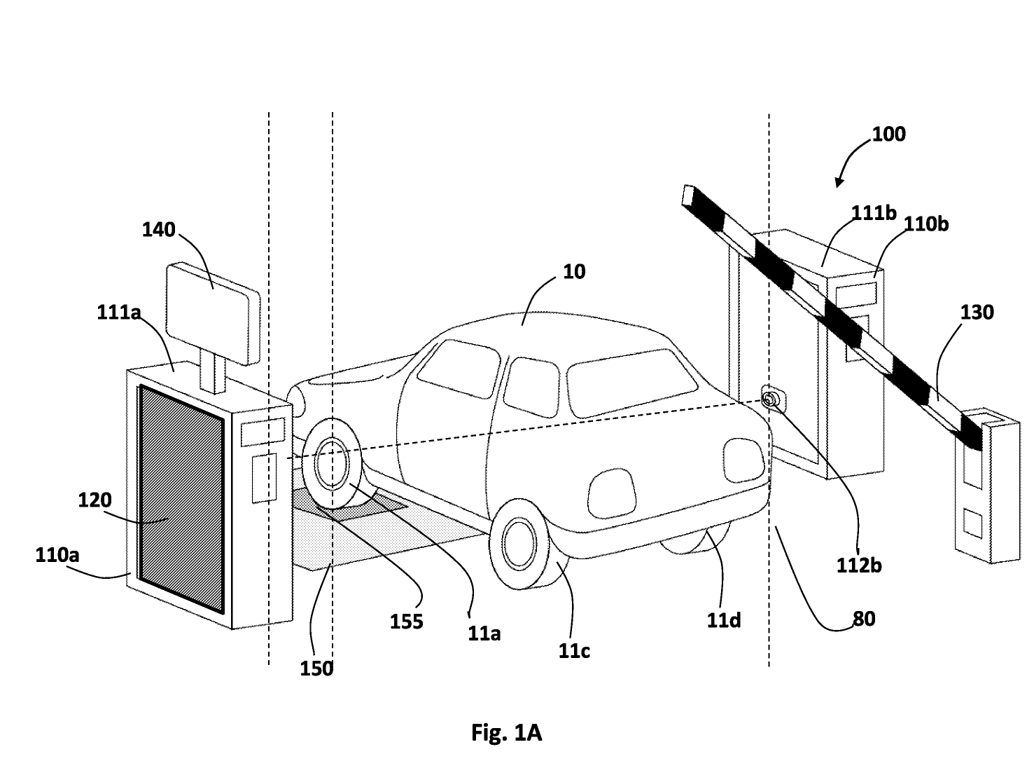

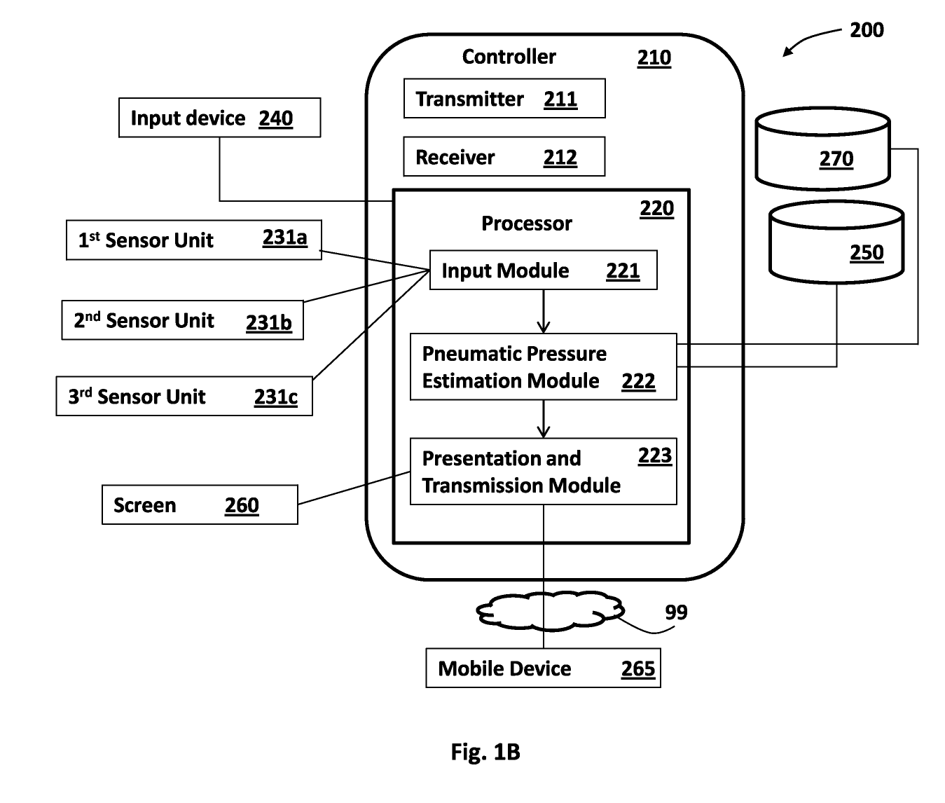

Reference is now made to FIG. 1A, which schematically illustrates a system 100 for estimating and presenting pneumatic pressure of vehicles' tires in a predefined passageway 150, according to some embodiments of the invention. This system 100 includes two sensor units 110a an 110b, each having a holder structure 111a and 111b, respectively, for holding at least one sensor such as a camera 112a and 112b, respectively and a controller 120 for receiving data from the cameras 111a-111b and processing it using image analysis to identify pneumatic pressure of vehicles' tires passing through a designated passageway 80 defined by the two holders 111a and 111b.

To direct a vehicle 10 driver to a desired position in respect to the cameras 112a-112b for allowing acquiring images of each pair of the vehicle's 10 wheels (front 11a and 11b and back 11c and 11d), one or more barriers such as electrically controlled barrier 130 may be located for defining the passageway 80 and for allowing the two sided cameras 112a and 112b to be positioned as accurately as possible in front of each pair of wheels of the vehicle while it passes through the passageway 80 to optimize image analysis. Additionally, the designated parking area 150 may be marked or made from a different flooring material that that of the surrounding flooring and may optionally also include stopper members 155 for allowing the driver to direct the vehicle 10 such that first the two front wheels 11a and 11b are stopped by the stopper members 155 and then the driver is required to drive further forwardly to allow the two rear wheels 11c and 11d to be stopped by the stopper members 155 for positioning the wheels and therefore the tires at the best position in front of the cameras 112ab and b112b substantially parallel to the holders' 111a and 111b inner sides.

For example, as illustrated in FIG. 1A, the vehicle 10 is directed to park in a positioning in which its front wheels 11a and 11b (11b is hidden at this view) are parked over the stopper members 155. This allows the cameras 112a (hidden at this view) and 112b, located at holders 111AB and 111B each defining a vertical axis z1 and z2, respectively, and 112b to be positioned in such that a horizontal axis x1 stretched between focal centers of the cameras 112a and 112b is substantially perpendicular to axes z1 and z2. The purpose is to bring each of wheels' pair (11a-11b or 11c-11d) in front of the center of the camera 112a or 112b to allow each camera to acquire at least one image of the tire/wheel positioned in front of it such that the tire in the image will be a less tilted as possible reflecting the frontal side of the image with optimal accuracy.

According to some embodiments of the present invention, the system also includes various additional sensors that can identify if the vehicle is parked in a position that is reasonable enough to allow begin acquiring images of the wheels for enabling estimating their tires' pneumatic pressure.

According to some embodiments of the invention, the system also includes a detector configured for detecting when the vehicle is in the camera(s) frame(s). This can be done via a ground loop, an electro-optic sensor, a volume based motion detector, magnetic detector or any other commercially available technology.

According to some embodiments of the invention, the system further includes one or more output devices such as a screen 130 or any other device that allows outputting an indication of the estimated pneumatic pressure of each of the vehicle's tires 11a-11d. For example, the controller 120 may allow displaying the actual estimated value of the pneumatic pressure of each tire and the tire's respective location (left front/rear or right front/rear) and/or simply indicate only the over or under inflated tires and their respective location (e.g. outputting a text message indicating that “left rear tire is underinflated”) and the like. Warning media effects may also be used to indicate values that exceed endangering values of pressure.

As illustrated in FIG. 1A, the controller 120 may also include one or more input devices such as input device 125 that allows the driver to input information that allows identifying his/her vehicle type (such as by selecting from a list and/or inputting free text) and optionally other information that will help assess the vehicle's wheels pneumatic pressure. As mentioned above, in other embodiments of the present invention, means for automatically identifying or assessing the type of the vehicles may be provided such as RFID based identification, image acquiring and analysis of the vehicle's license plate (LPR), image analysis of the wheel image to assess the vehicle's type and the like.

According to other embodiments of the present invention, the controller 120 may communicate with a remote processor such as a remote server, where the image analysis and estimation of pneumatic pressure is carried out by the remote server. This will allow a plurality of such systems located at different areas to communicate with the same main server for allowing a centralized control of all systems. Each system will then acquire the images and receive input data relating to the vehicles' types, transmit these images to the remote server and receive resulting estimated pneumatic pressure values for presenting an indication thereof.

Reference is now made to FIG. 1B, which is a block diagram of a system 200 for estimating and presenting pneumatic pressure of vehicles' tires, according to some embodiments of the present invention. The system 200 includes a controller 210; a plurality of sensor units such as first, second and third sensor units 231a, 231b and 231c and input device 240 an output device 260 and one or more databases such as databases 250 and 270.

The first and second sensor units 231a-231b include optical sensors for acquiring images of the vehicles' wheels in a similar manner as described in regards to FIG. 1A, while another third sensor unit 231c may be configured and positioned to allow sensing other parameters related of the vehicle such as the vehicle's license plate (by using optical sensors); the vehicle's positioning in relation to the first and second sensor units 231a-231b and/or for measuring other measures that can affect the tires condition and/or effect the recommended pneumatic pressure rate of tires such as the temperature of the tires which can be measured from a distance by using infrared (IR) sensors for example, and the like.

The temperature of the tires also affects the correct recommended pressure level it should be inflated to. Heated under or over inflated tires can easily tear and explode during driving. Therefore, the recommended inflation rate (pressure) for a heated tire is typically higher than recommended rate for the same tires of the same car type and location in the vehicle that is not heated. In general, tires should be checked and inflated when they are “cold”, i.e. before the vehicle is driven.

In these embodiments, in which the third sensor unit 231c includes one or more IR based sensors for measuring tires' temperature, the estimated pressure is compared with a known recommended pressure value of corresponding tires (of the same vehicle type and location) for the temperature range that corresponds to the measured one.

According to some embodiments the same or another sensor for measuring the external temperature such as a thermometer or by using the same IR sensor for instance, the external temperature is also indicated. The estimation module 222 may calculate the right value of a properly inflated corresponding tire for comparison with the estimated parameter value by using a predefined equation. This equation may include the value of this parameter inflated to the manufacturer's recommendation under “normal” conditions in which the ratio or difference between the external and tire temperatures is of a certain value or within a specific range having a factor that includes the relation between the external and tire temperatures multiplied by the normal conditions value.

According to some embodiments of the invention, as illustrated in FIG. 1B, The controller 210 includes a processor 220 that operates several modules: (i) an input module 221 that is configured to receive input data/signals from the sensor units 231a-231c via one or more communication links (which may be wireless or wired links and optionally also from the input device 240 for identifying the vehicle type via driver/user input; (ii) a pneumatic pressure estimation module 222 (shortly referred to as “estimation module”) for receiving the input data from the input module 221 and processing it for estimating the pneumatic pressure of the tires of the respective vehicle; and (iii) presentation module 223 for presenting the estimated pneumatic pressure and other related information via one or more output devices suing one or more presentation type such as visual (e.g. via a screen 260), audio (e.g. via speakers), printed textual presentation (e.g. by providing a printed note including the estimation and related information) and the like.

According to some embodiments of the present invention, the first database 250 includes a list of recommended values of tires' pneumatic pressures and of at least one parameter indicative of the tire's pressure such as footprint or sidewall height and the like each such value associated with a vehicle's type and location of the tire (front or back) to allow the estimation module 222 to compare the measured/calculated value of the corresponding parameter using image analysis of the tire's image with a compatible tire of the same vehicle type and positioning (rear/front) to allow estimating (a) the pneumatic pressure of the tire that is being examined; and (b) to allow estimating the difference between the recommended tire-pressure and the estimated one to calculate if and to what extent the examined tire is over or under inflated.

According to some embodiments of the present invention, the second database 270 includes lists of vehicles codes (e.g. for RFID vehicle identification and their associated vehicle related information including, for instance, vehicle type, year of manufacturing, color, etc.

According to optional embodiments of the invention, the presentation and transmission module 223 further enables communicating with drivers' mobile devices such as mobile phones 265, tablet devices and the like for transmitting text messages available messaging technologies such as emails, short messaging systems (SMS), via native or web based applications over one or more communication networks and links such as wireless link 99. The message may include information indicative of the estimated pneumatic pressure state of their tires.

To communicate with the sensor units 231a-231c and/or with the mobile, input and output devices 265, 240, 260, respectively, the controller 211 includes one or more transmitters 211 and receivers 212 for allowing wirelessly communicating with multiple devices using various communication technologies, frequency ranges and/or networks.

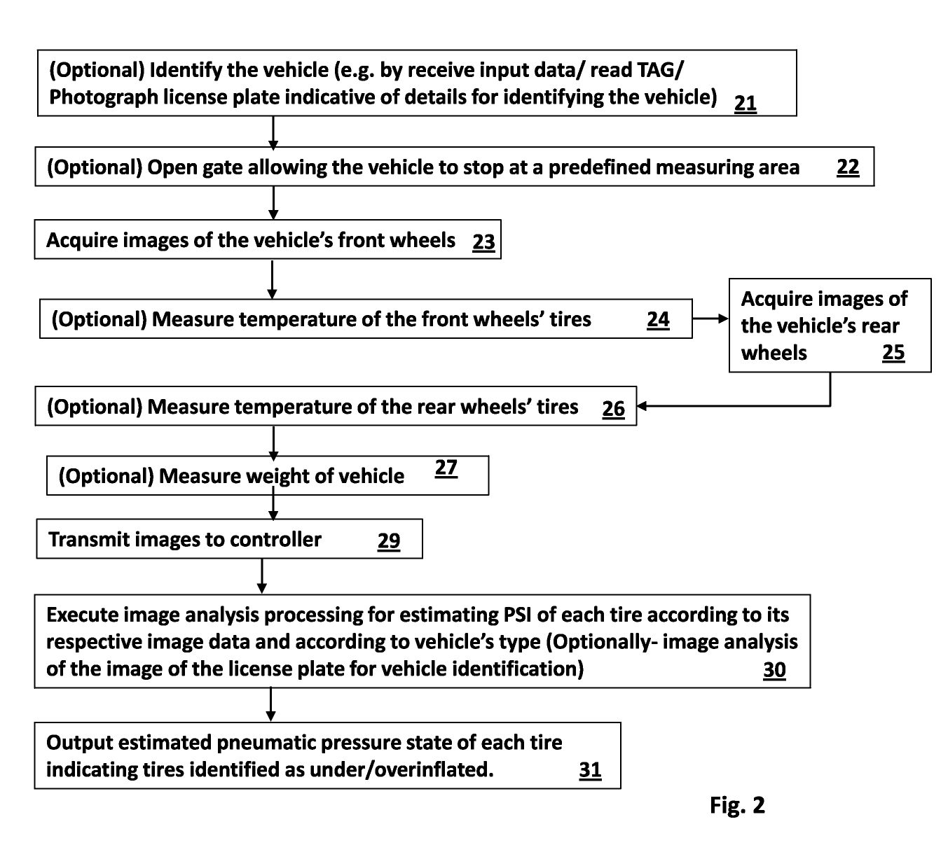

FIG. 2 is a flowchart, schematically illustrating a method for estimating and presenting pneumatic pressure in vehicles' tires, according to some embodiments of the present invention. The method includes acquiring images of the front wheels 23 e.g. by simultaneously operating cameras located at both sides of the vehicle when the vehicle passes through a predefined area. At the same time the front wheels are photographed to acquire images thereof, other optical devices such as IR cameras may be used to measure the temperature of the front wheels' tires 24 as well as their distance from the cameras and sensors. Then the same steps including acquiring images of the wheels and temperature of their tires may be carried out for the rear wheels as shown in steps 25-26 of the flowchart in FIG. 2.

Once the images of the front and rear wheels have been acquired, they are transmitted to a processor, which may be operated via a controller 29 for processing thereof. This processor then executes an image analysis process (operated by a computer or via on-chip processing such as by using microprocessors), in which each wheel image is analyzed to estimate its respective tire's pneumatic pressure state 30. This may be carried out by measuring one or more parameters in the wheel's image such as footprint or sidewall height through the image analysis and then comparing it with known value of a properly inflated front/rear tire in respect to the side (front/rear) of the wheel image in process. To do so, the type of the vehicle should be known, since each manufacturer of each vehicle type uses different wheel designs and tires and each vehicle type has different recommended rear and front tires' pneumatic pressure values. Therefore, another step or process for identifying the vehicle can be included in this method 21. This step (21) may be carried out before or after the wheels images are acquired. In the example of FIG. 2 the vehicle identification occurs before acquiring the wheels' images.

Once the image analysis is done and the pneumatic pressure of each of the vehicle's tires is estimated, an indication of the pneumatic pressure of each tire is outputted for presentation thereof 31. The indication may include the values of the tires' pneumatic pressure and/or an indication that shows if these values exceed a range or a desired pneumatic pressure value of a corresponding properly inflated tire—meaning that a visual indication is given to illustrate whether the tire is properly, over or under inflated.

According to some embodiments, an initial process including image analysis may be executed for obtaining dimensions and ratios of the tire and wheel components. Then the output of the initial process, including for example, estimated dimensions of the tire, these estimated parameters are compared to corresponding parameters in the database using separate algorithms for carrying out the initial process.

As illustrated in FIG. 1A, the system 100 may be positioned in an entrance area directing vehicles into a predefined parking area where each vehicle entering the parking area has its tires' inflation rate estimated and indicated while passing through the entrance passageway. This can be very useful, for example, for parking areas of large vehicle stations all belonging to the same business such as for central bus or taxi stations allowing a central controller having a central computerized system communicative with one or more such systems located in one or more entrances of the station parking area to supervise the pressure state of all the tires of all vehicles of the business in an easy and less time-consuming manner. In this example the supervisor can receive visual indications through text messages or directly to a central screen thereof where each vehicle of the business having under/over inflated tire(s) is identified and indicated alerting the supervisor as to which vehicles require treatment. In these cases data associated with each identified and examined vehicle is stored at a computerized storage unit of the system or on a cloud server to allow retrospective inspection and recordation of the history of the vehicles' tires' pressure states.

Optionally, as illustrated in FIG. 2, the vehicle's weight is also measured 27, using one or more special weighing devices such as pressure sensors (e.g. based on piezoelectric transducers).

According to some embodiments of the present invention, the system and method further enable registering entry of each vehicle from the passageway area and exiting therefrom for other purposes.

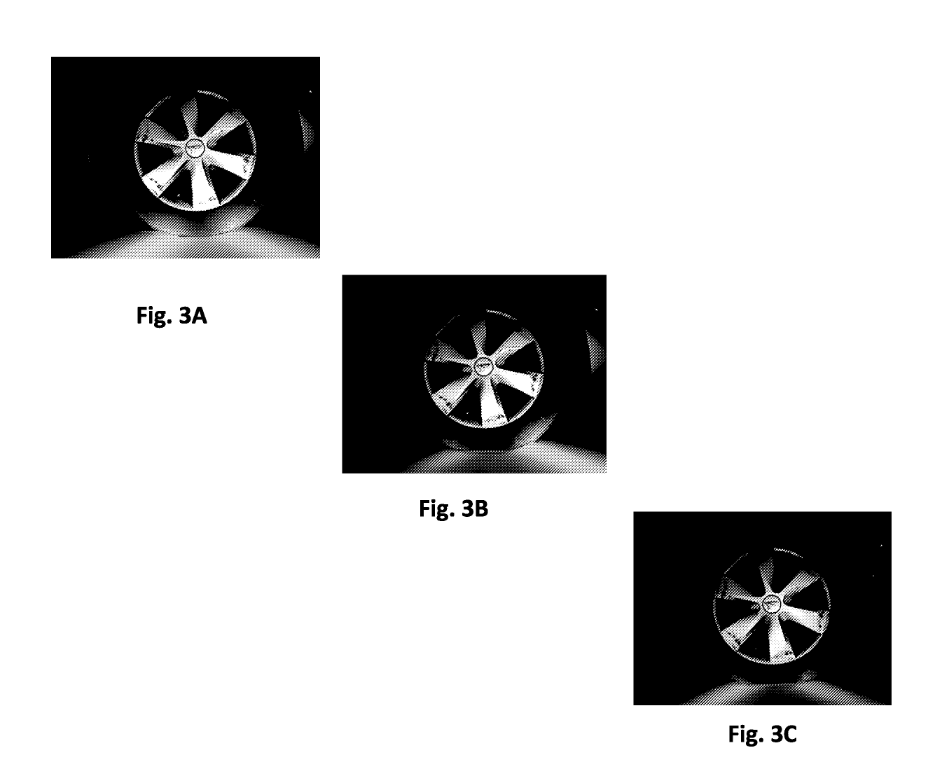

Reference is now made to FIGS. 3A-3C which show how the pneumatic pressure level of a tire influences the footprint of the tire. FIG. 3A shows a photograph of a vehicle's tire inflated to 34 PSI (pounds per square inch); FIG. 3B shows a photograph of the same tire inflated to 24 PSI; and FIG. 3C shows a photograph of the same tire inflated to 15 PSI. It is clear from these photographed experiments that the footprint lengthens with the decreasing of the tire's pneumatic pressure.

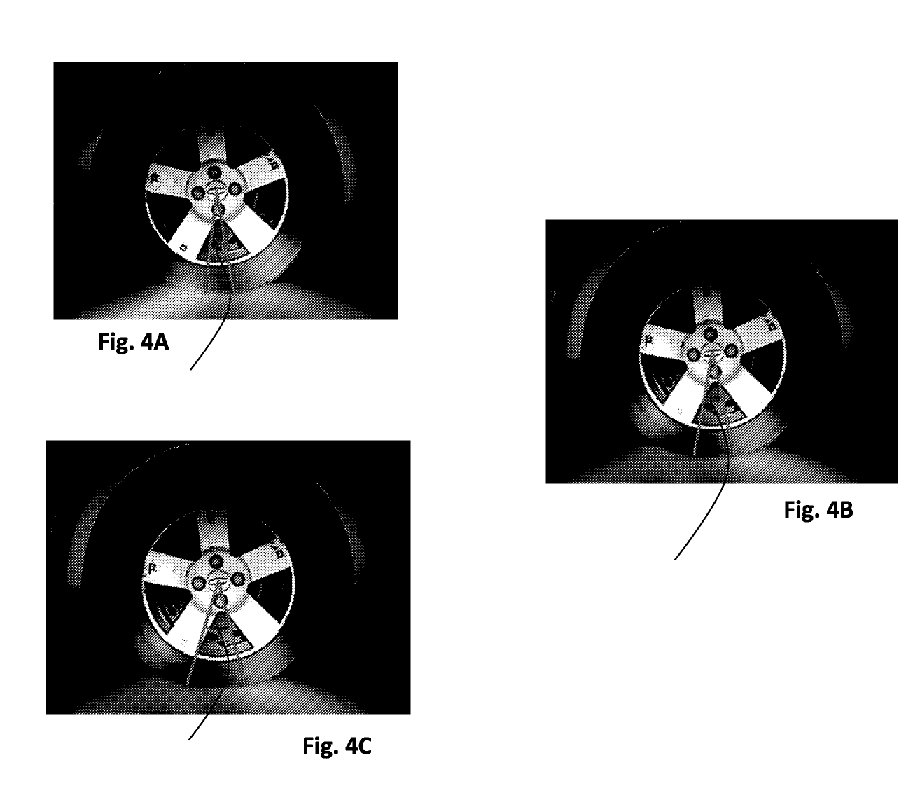

FIGS. 4A-4C show how the pneumatic pressure level of a tire influences the footprint angle of the tire: FIG. 4A shows a photograph of a vehicle's tire inflated to 28 PSI (pounds per square inch); FIG. 4B shows a photograph of the same tire inflated to 22 PSI; and FIG. 4C shows a photograph of the same tire inflated to 15 PSI. It is clear from these photographed experiments that the footprint angle widens with the decreasing of the tire's pneumatic pressure.

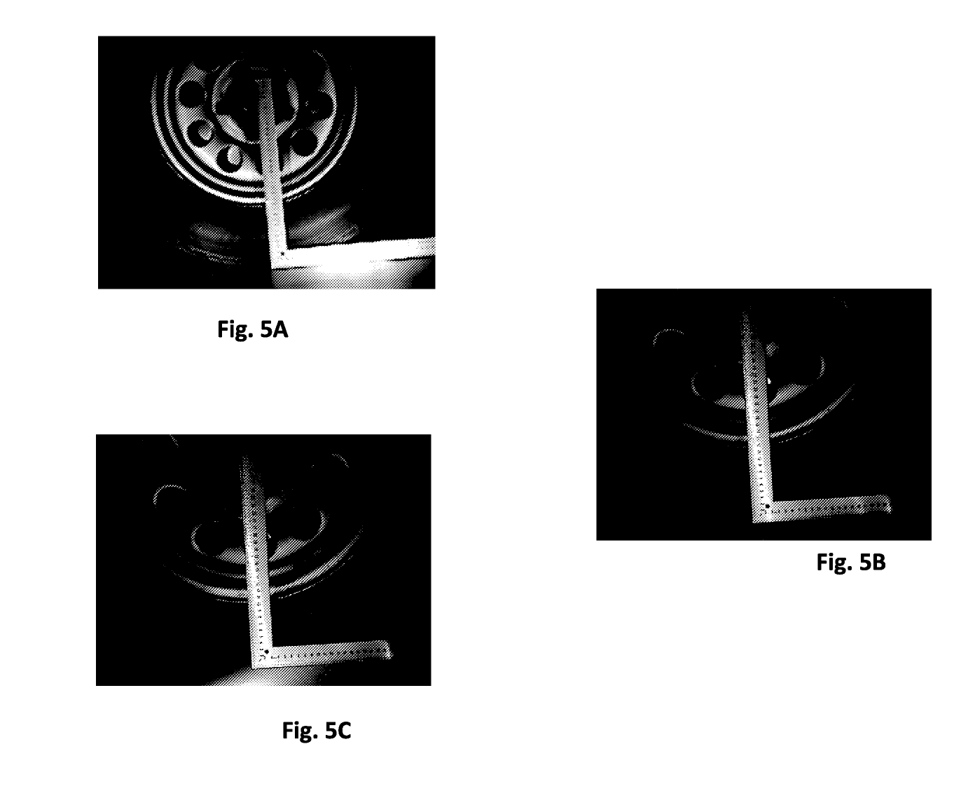

FIGS. 5A-5C show how the pneumatic pressure level of a tire influences the sidewall height measured between the touch point between the tire and road/ground and a the inner side of the tire (the contact point with the rim): FIG. 5A shows a photograph of a vehicle's tire inflated to 36 PSI (pounds per square inch); FIG. 5B shows a photograph of the same tire inflated to 27 PSI; and FIG. 5C shows a photograph of the same tire inflated to 10 PSI. It is clear from these photographed experiments that the sidewall height decreases when the tire's pneumatic pressure is decreased.

These experiments may be taken for many vehicles' front and rear tires to establish a table (to be stored in a computerized data storage unit such as a database) associating the vehicle's type, tire side (rear/front), recommended pneumatic pressure value and its associated footprint length, sidewall height and/or footprint angle. This will allow carrying an image processing of the respective tire for measuring the respective parameter(s) (footprint length, sidewall height and/or footprint angle) and then checking the resulting value(s) thereof with the standard parameter(s) value(s) of the tire of the same side and vehicle type. This table may additionally include the values of these parameters and of the recommended pneumatic pressure for the same tire (of the same side and vehicle's type) under various “tire conditions” such as under various tire-temperatures and/or vehicle's weight, for which the pneumatic pressure values and therefore the respective parameters' values vary correspondently.

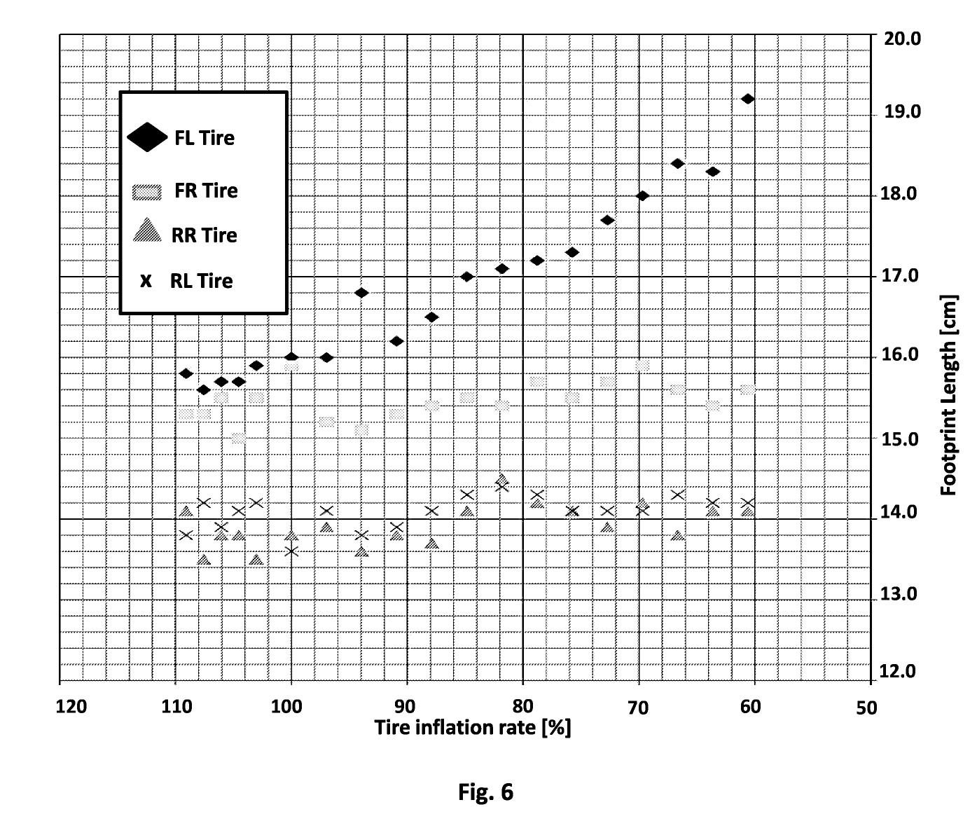

The graphs in FIGS. 6-8 show experimental results testing the relation between one of the above-mentioned parameters with the pneumatic pressure level of the tires. FIG. 6 shows that the deflation of a single front left tire, for example, has almost no effect on the other tires carrying the load of the vehicle, and only affects its own footprint length.

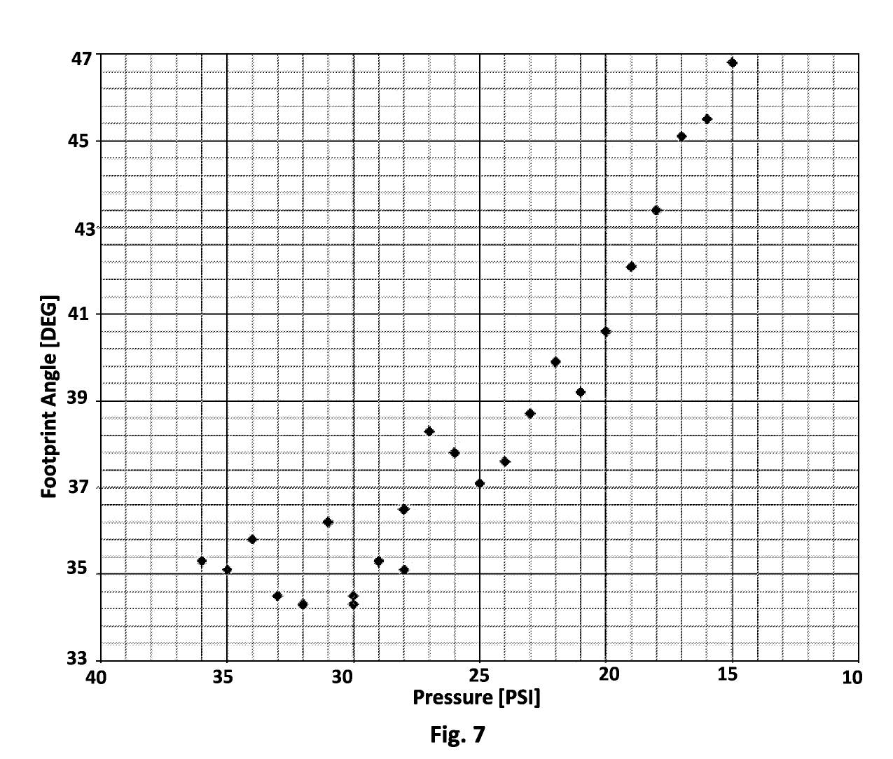

FIG. 7 shows the relation between the pressure value in [PSI} and the footprint angle for one of the vehicle's tires, where the lower the pneumatic pressure the larger the footprint angle aperture.

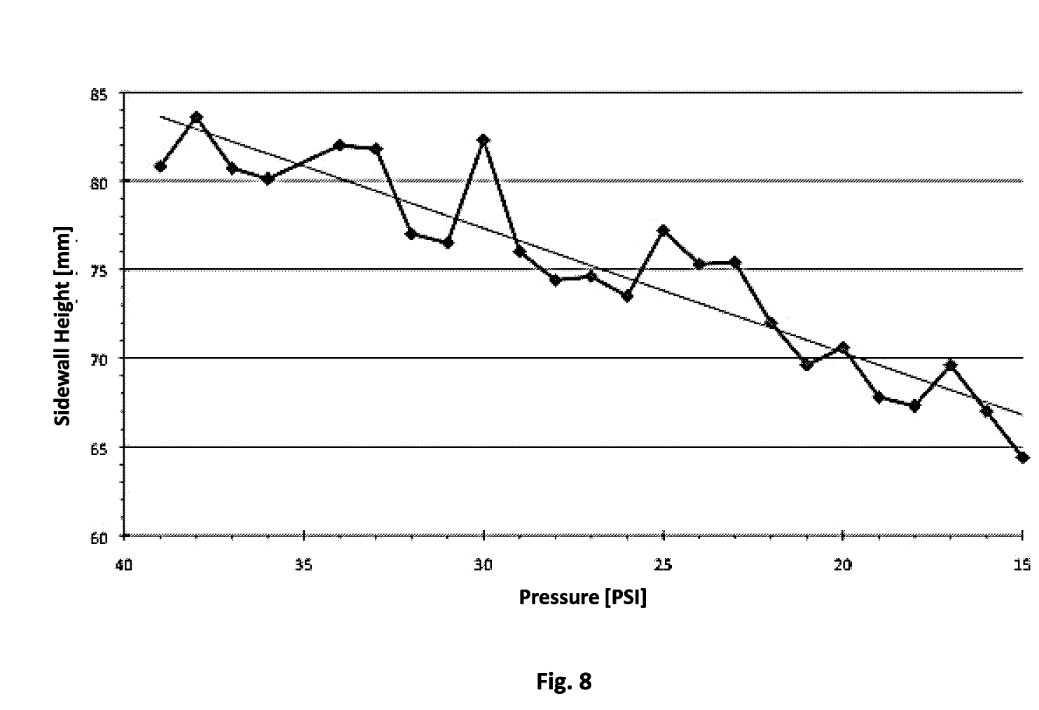

FIG. 8 shows the relation between the pressure value in [PSI} and the sidewall height for one of the vehicle's tires, where the lower the pneumatic pressure the smaller the sidewall height.

The image analysis may include a preliminary procedure allowing executing a preliminary testing process in which each acquired image is tested to check for defects therein and verify whether or not it passes at least one predefined quality criteria. In this process, upon failure of an image to pass one or more of the tested criteria the camera that has acquired this image is readjusted (e.g. by readjusting its zoom and/or camera orientation) according to the detected defects for acquiring a new image of the respective wheel.

This process may include verifying that: (i) the image is of a satisfying quality; (ii) the wheel image is not over-tilted or distorted in any other manner so that its desired features, from which the parameters are extracted/calculated such as the tire's inner and outer circumference outlines, are not too distorted.

The distortion defects such as tilted positioning of the wheel in respect to the camera can be corrected via image analysis or, if the distortion is too strong, the respective camera, photographing the specific wheel may be re-operated to adjust its zoom, dynamic range and/or orientation to acquire a better image of the respective wheel. For example, a preliminary testing process may be executed, in which each acquired image is tested to check for defects therein and verify that it passes at least one predefined quality criteria, wherein upon failure of an image to pass at least one of the tested criteria the camera is adjusted according to the identified defects for acquiring a new image of the respective wheel.

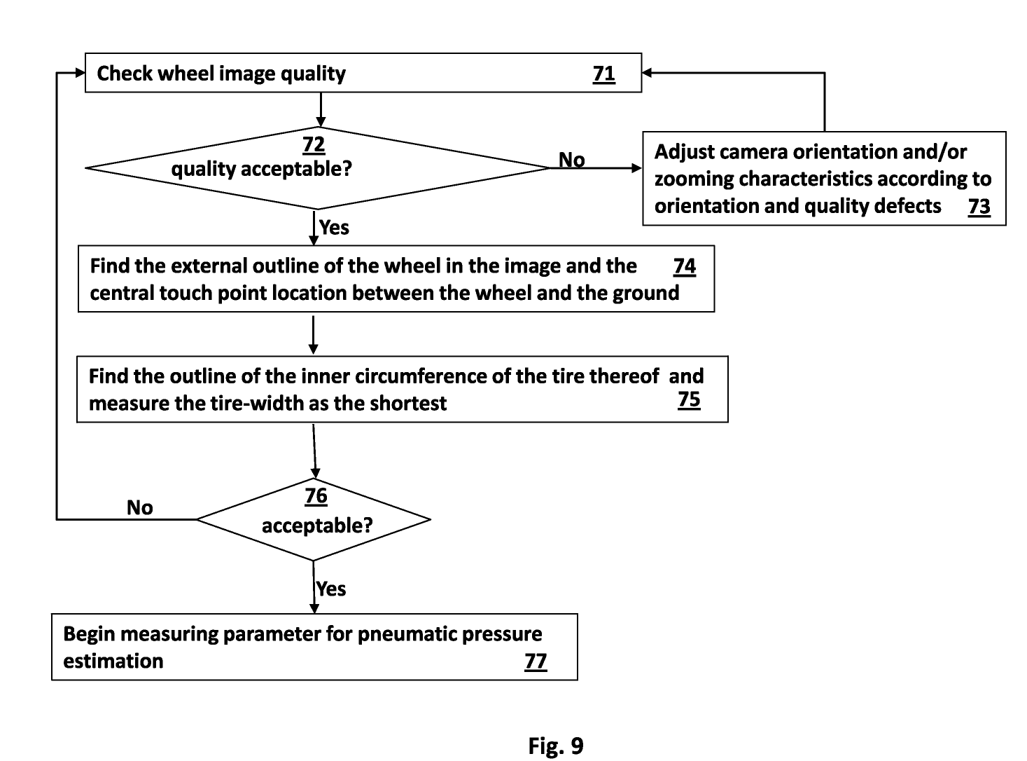

FIG. 9 is a flowchart, schematically illustrating a testing and measuring process for checking image quality before estimation of the pneumatic pressure state of the tire, according to some embodiments of the present invention.

In this process the wheel image is checked to verify its image-quality and distortions 71. If the quality of the image is not sufficiently acceptable (according to predefined conditions) and affecting distortions are identified 72 (meaning that the wheel is too tilted in respect to the camera), the camera is adjusted 73 by, for example, adjusting its orientation in respect to its main axis and/or adjusting its zoom and dynamic range and/or other such features. Once the camera is adjusted 73 the wheel is photographed again to acquire a new and hopefully a better image thereof. This process can be carried out a predefined number of times until reaching an acceptable image quality, where if after a predefined number of such iterations the image is not yet acceptable the driver may be required to changes his parking position in respect to the sensor unit.

According to other embodiments, the cameras used are video cameras where the best image or images of a video sequence of the camera, relating to the respective wheel, is/are selected, according to predefined criteria using preliminary image analysis for identifying suitable image(s). For example, the preliminary image analysis includes verifying that the entire wheel is captured in the frame of the image, that it is not tilted in relation to the focal plane of the camera and the like.

If the quality of the image is sufficiently acceptable and the distortions is of little effect (meaning that the wheel substantially faces the front of the camera) 72 then the image analysis algorithm begins measuring one or more parameters for estimating the pressure level of the tire the respective wheel. The preliminary process also includes checking the circular characteristics of the wheel's tire in the image as shown in FIG. 9, where the inner and outer rims of the tire of the wheel are identified 74-75 and then checked to see if the wheel is oriented in respect to the focal plane of the camera by checking the circular characteristics of the inner and outer circumferences of the tire. If the image is then accepted 76 the process of measuring the one or more parameters such as the footprint length and/or the sidewall height may begin 77. If the image is not accepted according to the circularity check criteria, then another image is acquired. The preliminary testing procedure may be carried out very rapidly as the vehicle drives along the passageway.

According to some embodiments of the invention, the system also includes a mechanical camera positioning mechanism to allow adjusting the location of the camera over at least one axis, and/or uses a High Definition (HD) digital camera, with the ability to perform a digital zoom to the area of interest (where the wheel is found in the frame). For example the height of each camera in respect to the ground/road may be adjusted and held in the selected positioning by using any means known in the art such as by using a track and an automatically and electrically controlled stopper that can move along the track and have a mechanism that allows it to grab onto the track when reaching the selected height. The height may be adjusted according to the identified image defects and/or before acquiring the images—according to the vehicle's type. Once the vehicle is identified, the optimal height of the cameras may be calculated by the processor and then adjusted, according to the known diameter of the specific vehicle's wheel, for instance.

According to some embodiments the measured parameter value is compared with a corresponding known value of a properly inflated equivalent tire of the same vehicle type and tire-side (rear/front) where since the relation between the inflation rate and the parameter value is statistically and experimentally documented the comparison is carried out between those measured and known parameters to estimate the pneumatic pressure state in a more general manner without calculating the exact pneumatic pressure value of the tested tire. For example, since the less the tire is inflated the longer the footprint—the measured footprint length may be compared with a known one, where if the measured footprint length is shorter than that of the known one an indication that the tested tire is overinflated and if the measured footprint length is longer that the known one, an indication that the tire is underinflated is outputted/presented.

To convert the scale of the image to a real scale Hough transformation algorithms may be used, where proportions are determined by comparing the pixel size of an item of a known size such as the rim, or even the bolts that connect the wheel to the car, to their real known physical size, by measuring the range between the camera or sensors to the object or by other means that are known to those skilled in the art. Another method for scaling is by measuring the distance of the object via a distance measuring device such as laser, by using two cameras positioned in parallel, or by comparing images taken from both sides of the car, when the distance between the sensors is known, and the width of the vehicle may also be known from the database.

When using computer based image processing, some embodiments of the present invention might be sensitive to light and shade so appropriate lighting may need to be added to the system in the form of ambient light, spot lights or other commercially available illumination solutions to improve both image quality and to avoid some illumination-related image distortions. These may also be infra-red (IR) lightings, supported by the appropriate filters on the cameras.

Additionally or alternatively, the measurement of the footprint length may be performed by physical sensors such as pressure switches or strain gauges or other commercially available speed detection solutions can calculate vehicle speed, which after simple time integration can lead to the calculation of the footprint length.

Another method for measuring the footprint length is by using a laser beam running in a fiber optic cable that is attenuated when pressed by the weight load of a tire so that the length of the footprint can be extracted for a static tire if the optic cable that runs in the general direction along the path of the vehicle, or when one or more cables are set generally perpendicular to the path of the vehicle, by using time integration.

According to some embodiments of the present invention, to estimate the value of the pneumatic pressure of the respective tested tire, while measuring one or more of the above-mentioned parameters, one or more conversion equations may be used deduced from the relation between the pressure value and the specific parameter to calculate the pressure value. For example, since there is a near linear relation between tire footprint length and the equivalent pneumatic pressure, knowing the linear constants A and B for the equation “y=Ax+B”, where “y” is the footprint length and “x” is the equivalent pressure, allows for the extraction of the equivalent pressure using the equation “x=(y−B)/A”. As shown before, this correlation can also be done with other parameters having linear correlation with the pneumatic pressure of the tire such as footprint angle and sidewall height. This can also be performed for a polynomial equation of a higher degree.

According to some embodiments more than one parameter can be measured each used for separately calculating the tire's pneumatic pressure, where these two results are then averaged or combined to achieve a more accurate estimation.

According to some embodiments of the invention, instead of having the vehicle identified, a raw estimation of the pneumatic pressure state (inflation state) of the tire can be carried out by using a predefined estimation equation for calculating an acceptable parameter value/range, where the value of the measured parameter is then compared to the calculated acceptable value or range to see if the tire is properly, over or under inflated. For example, the acceptable footprint length range may be between a first and second portions (fractions such as between 1/10 and ⅕) of the entire circumference length of the tire's outer rim. The footprint is then estimated via image analysis or directly measured, for instance, and the estimated/measured length is then checked to verify whether it exceeds the calculated range.

According to some embodiments of the present invention, the system further includes a decelerating mechanism such as a bumper, a barrier, a colored platform, and/or a scraped road section for forcing the passing vehicles to decelerate when approaching the designated passageway.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

What is claimed is:

1. A system for estimating pneumatic pressure state of vehicle tires, said system comprising:
(a) at least one sensor unit, each comprising at least one optical sensor for acquiring at least one image of at least one wheel of the respective vehicle; and
(b) at least one controller comprising at least one processor for receiving image data of a respective wheel of the vehicle from said sensor unit and analyzing thereof for estimating a pneumatic pressure state of a tire of said wheel, said processor is configured to allow presenting the estimated pneumatic pressure state of each respective tire,
wherein said image analysis comprises estimating value of at least one predefined parameter of the respective tire in the image and comparing the estimated parameter with a known value of a corresponding parameter of a properly inflated tire, and
wherein said at least one parameter comprises at least a footprint length of the tire defined as a portion of an external periphery of the tire in the image that is in contact with the ground.

2. The system according to claim 1, wherein said comparing of the estimated parameter with a known value of a corresponding parameter, uses at least one database for retrieving known parameter values.

3. The system according to claim 1, further comprising at least one input device for allowing a user to input data therethrough, said input data comprises at least the type of the respective vehicle, wherein said processor uses said input data for estimating the pneumatic pressure state of each tire of the respective vehicle.

4. The system according to claim 3, wherein said at least one sensor unit comprises a plurality of sensor units located such as to allow a vehicle to pass there-between for acquiring images of all the wheels of the respective passing vehicle when passing through said sensor units, wherein upon passage of the respective vehicle, said sensor units enable identifying and indicating the respective left/right and rear-front location of each tire in each image,
wherein said database associates each known parameter value with a specific vehicle type and with a tire side indication indicative of the front/rear side of the respective tire in the image for allowing said processor to compare the estimated value of the parameter with a corresponding parameter value of a properly inflated tire that is of the same vehicle type and tire side.

5. The system according to claim 1, wherein said at least one parameter further comprises at least one of: footprint angle; and sidewall height.

6. The system according to claim 1 further comprising at least one temperature measuring device for measuring the temperature of the respective tire, said processor, which is configured to communicate with said temperature measuring device, enables using said temperature of the respective tire for estimating its pneumatic pressure state in respect to known values of properly inflated tires within the respective temperature range.

7. The system according to claim 6, wherein said temperature measuring device comprises an Infrared based sensor or camera.

8. The system according to claim 1 is located at a designated passageway for allowing vehicles to have their tires' pneumatic pressure state estimated while passing through said passageway, wherein said at least one sensor unit comprises a plurality of sensor units configured for producing 2D images of each pair of tires of the vehicle substantially simultaneously by being installed at opposite sides of said passageway,

9. The system according to claim 1 further comprising an output device for presenting said outputted estimated pneumatic pressure state.

10. The system according to claim 9, wherein said output device comprises at least one of: at least one screen, at least one speaker; at least one printing device for outputting printed text messages indicative of said estimated pneumatic pressure state

11. The system according to claim 9 further comprising a plurality of pressure detectors each located over said passageway such that the tires of the passing vehicles are forced to role thereover when passing therethrough, said pressure detectors are configured for estimating pressure applied by each tire, wherein detection of each applied pressure of each of a respective vehicle's tires is received at said processor and used thereby in estimating tires' pneumatic pressure.

12. The system according to claim 1 further comprising an automatic vehicle type identification mechanism for automatically identifying the type of the respective vehicle, wherein said estimation of said pneumatic pressure of each tire of the respective vehicle is carried out according to the type of the respective vehicle.

13. The system according to claim 12, wherein said vehicle identification mechanism is configured for one of: identifying the license number of the vehicle via LPR; RFID identification of the vehicle, wherein said processor enables accessing at least one database for associating the identified license number or RFID code with a type of the respective vehicle.

14. The system according to claim 1 further comprising a mechanical positioning mechanism to allow adjusting the location of each optical sensor over at least one axis, said mechanical positioning mechanism is electrically controlled by said controller.

15. A method of estimating pneumatic pressure in tires of vehicles, said method comprising:
a) acquiring at least one image of at least one of wheel of a vehicle, using at least one sensor unit comprising an optical sensor;
b) analyzing each respective image of each tire of the respective wheel for estimating value of at least one parameter of said tire related to pneumatic pressure thereof and comparing the estimated parameter with a known value of a corresponding parameter of a properly inflated tire, wherein said at least one parameter comprises at least a footprint length of the tire defined as a portion of an external periphery of the tire in the image that is in contact with the ground;
c) estimating pneumatic pressure state of the respective tire by comparing the estimated value of said parameter with a known parameter value of a properly inflated corresponding tire; and
d) presenting an indication of said estimated pneumatic pressure state.

16. The method according to claim 15, wherein said at least one parameter further comprises at least one of: footprint angle; and sidewall height.

17. The method according to claim 15 further comprising identifying type of the respective vehicle and identifying the rear/front side of each wheel in each image, wherein said estimated parameter is compared to a corresponding known parameter associated with the same vehicle type and tire side.

18. The method according to claim 17 further comprising receiving input data indicative of the type of the respective vehicle.

19. The method according to claim 17 further comprising automatically identifying the vehicle by using at least one sensor for sensing at least one parameter associated with the type of the respective vehicle.

20. The method according to claim 17 further comprising adjusting the positioning of each said optical sensor according to the identified vehicle type before acquiring image of its wheels.

21. The method according to claim 15 further comprising executing a preliminary testing process in which each acquired image is tested to check for defects thereof and verify that it passes at least one predefined quality criteria, wherein upon failure of an image to pass at least one of the tested criteria said sensor of said sensor unit is adjusted according to the detected defects for acquiring a new image of the respective wheel.

22. The method according to claim 21 wherein zoom and/or dynamic range of the sensor are adjusted, wherein said sensor comprises at least one camera with adjustable zoom and dynamic range.
